(19) United States
(12) Patent Application Publication
(10) Pub. No.: US 2004/0214090 A1
(43) Pub. Date: Oct. 28, 2004

(54) Polymer electrolyte for electrochemical cell

(76) Inventors: Robert C West, Madison, WI (US); Qingzheng Wang, Glen Ellyn, IL (US); Khalil Amine, Downers Grove, IL (US)

Correspondence Address: M Elizabeth Bush, Quallion, P O Box 923127, Sylmar, CA, 91392-3127, US

(21) Appl. No.: 10/491,071

(22) PCT Filed: Mar. 20, 2003
(86) PCT No.: PCT/US03/08779

(30) Foreign Application Priority Data
Mar. 22, 2002 (US) 10104352
Jun. 12, 2002 (US) 10/167940
Jan. 22, 2003 (WO) PCT/US03/02127
Jan. 22, 2003 (WO) PCT/US03/02128
Jan. 30, 2003 (US) 60443892
Feb. 11, 2003 (US) 60446848
Feb. 26, 2003 (US) 60451065

(51) Int. Cl. H01M 10/40; H01G 9/025

(52) U.S. Cl. 429/311; 429/313; 429/317; 429/309; 429/316; 429/307; 361/525; 361/527

(57) ABSTRACT

Disclosed is a cyclic siloxane polymer electrolyte for use in lithium electrochemical storage devices such as secondary batteries and capacitors. Electrolyte polymers comprising poly(siloxane-g-ethylene oxides) with one or more poly(ethylene oxide) side chains directly bonded to Si atoms are convenient to synthesize, have a long shelf life, have ionic conductivity of over 10⁻⁴ S/cm at room temperature, do not evaporate up to 150° C., have a wide electrochemical stability window of over 4.5 V (vs. lithium), and are not flammable. Viscosity and conductivity can be optimized by controlling the size of siloxane ring or the length of poly(ethylene oxide) side chain. The polymer disclosed may also be used in solid electrolyte applications by use of solidifying agents or entrapping within solid polymers. Means to synthesize both 8 and 10 membered rings are described using both boron and triethylamine as catalysts.

### REFERENCE TO PRIOR FILED APPLICATIONS

This application claims priority to copending provisional application Ser. No. 60/443,892 entitled “Nonaqueous Liquid Electrolyte” filed Jan. 30, 2003; and to PCT/US03/02127, filed Jan. 22, 2003; and to PCT/US03/02128, filed Jan. 22, 2003; and to copending U.S. application Ser. No. 10/167,490 filed Jun. 12, 2002, which is a Continuation-in-Part of co-pending U.S. application Ser. No. 10/104,352, filed Mar. 22, 2002, the disclosure of each of which is incorporated herein in its entirety by reference, including all disclosures submitted therewith.

### GOVERNMENT LICENSE RIGHTS

This invention was made with United States Government support under NIST ATP Award No. 70NANB043022 awarded by the National Institute of Standards and Technology (NIST). The United States Government has certain rights in this invention pursuant to NIST ATP Award No. 70NANB043022 and pursuant to Contract No. W-31-109-ENG-38 between the United States Government and the University of Chicago representing Argonne National Laboratory, and NIST 144 LM01, Subcontract No. AGT DTD 09/09/02.

### FIELD OF THE INVENTION

The present invention relates to electrolytes for rechargeable electrochemical cells, and, more particularly to cyclic siloxane polymer electrolytes with a poly(ethylene oxide) as a pendant group.

### BACKGROUND

The demand for lithium secondary batteries to meet high power and high-energy system applications has resulted in substantial research and development activities to improve their safety, as well as performance. As the world becomes increasingly dependent on portable electronic devices, and looks toward increased use of electrochemical storage devices for vehicles, power distribution load leveling and the like, it is increasingly important that the safety of such devices be paramount, especially as these devices are being used in such environments as airliners and space vehicles. Similarly, safety for medical applications must be paramount. The effort to date has included research in flame-retardants, solid polymer electrolytes, and new electrolyte concepts with improved thermostability. Thus, the development of highly conductive electrolytes, free of any problems associated with volatile and combustible solvents, is of paramount importance.

Polymer electrolytes have a number of advantages over the materials currently used in high-performance batteries. Compared to conventional batteries using heavy metals such as lead, nickel, and cadmium, the lithium-based polymer electrolyte batteries would be many times lighter. The proposed designs of these batteries would also allow them to be formed into various shapes besides the traditional cylindrical or rectangular shapes typical in regular batteries. (See, Gray, F. M. Solid Polymer Electrolytes; VCH Publishers: New York, 1991, at 1-4, 5-21). These advantages have fueled commercial interests and research interests into improving the conductive properties of polymer electrolytes. Poly(ethylene oxide) (PEO) has been known to dissolve alkali metal salts and exhibit conductivity since the early 1970's. (See, Fenton, D. E.; Parker, J. M.; Wright, P. V. Polymer 1973, 14, at 589). The properties of PEO have been studied extensively and are outlined in a number of review articles and texts. (See Gray supra; See also, Shriver, D. F.; Bruce, P. G. in Solid State Electrochemistry, P. G. Bruce, ed., Cambridge University Press: New York, 1995, at 95, 97-106). Of more recent interest has been a class of polymers with Si—O backbones known as polysiloxanes. (See, Mark, J. E.; Allcock, H. R.; West, R. Inorganic Polymers; Prentice Hall: New Jersey, 1992, at 3). The Si—O backbone of these polymers is highly flexible, yet retains its chemical and thermal integrity. Polysiloxanes also have low glass transition temperatures, T_{g}, and solvate lithium salts, making the polysiloxanes good candidates for potentially useful polymer electrolytes. (See, Hooper, R.; Lyons, L. J.; Mapes, M. K.; Schumacher, D.; Moline, D. A.; West, R. Macromolecules 2001, 34, 931. R. Hooper, L. J. Lyons, D. A. Moline, R. West, Silicon Chemistry 2002, 1, at 121; Lin, C.; Kao, H.; Wu, R.; Kuo, P. Macromolecules 2002, 35, at 3083; Zhou, G.; Khan, I. M.; Smid, J. Macromolecules 1993, 26, at 2202; Siska, D. P.; Shriver, D. F. Chem. Mater 2001, 13, at 4698; Zhu, Z.; Einset, A. G.; Yang, C.; Chen, W.; Wnek, G. E. Zhu, Z.; Einset, A. G.; Yang, C.; Chen, W.; Wnek, G. E. Macromolecules 1994, 27, at 4076; Zhu, Z.; Einset, A. G.; Yang, C.; Chen, W.; Wnek, G. E.; Fish, D; Khan, I. M.; Wu, E.; Smid, J. British Polymer Journal 1988, 20, at 286; Morales, E.; Acosta, J. L. Electrochimica Acta 1999, 45, at 1049.)

Carbonate solvents, such as ethylene carbonate and propylene carbonate used for conventional lithium battery electrolytes, can easily burn with a source of ignition and generate flame, carbon dioxide, and hydrocarbons during thermal degradation. In addition, carbonate solvents are easily reduced or oxidized at the surface of either the positive or the negative electrode, leading to an increase in impedance and capacity fade of the cell. Furthermore, at elevated temperatures, carbonate solvents used in lithium ion batteries react extremely exothermically with the charged electrode, potentially leading to thermal runaway of the battery. The reactivity between the carbonate solvent and the electrodes become significant, especially when the battery is large, such as in the case of hybrid and electric vehicles, satellites, submarines, and load leveling facilities, as well as medical devices and consumer electronics. Polymeric compounds, however, have different combustion mechanisms than carbonates.

The initial stage of a fire occurs when a source of ignition decomposes the polymeric materials into flammable volatile products. Thus, for the continuous burning to occur, (a) the application of heat must be sufficient to decompose the polymer, (b) the temperature must be sufficient to ignite the products of decomposition, and (c) the amount of heat transferred from the flame back to the polymer must be sufficient to maintain the cycle. In general, polymeric materials are more thermally stable than low molecular weight chemicals like carbonates because they are not volatile, and they vaporize at much higher temperatures.

Electrolytes based on polymeric structure have fundamentally better heat resistance than conventional carbonate based electrolytes and can reduce many side chemical reactions occurring in a lithium secondary battery under abnormal operating conditions such as temperatures exceeding 60° C. Although the electrolytes with polymeric structure have advantages over carbonate solvent based electrolytes, their application in lithium secondary batteries as an ionic conducting medium has been limited due to low ionic conductivity, usually below 10⁻⁵ S/cm at room temperature. To solve this problem, a liquid polymer electrolyte that does not evaporate at temperatures up to 150° C., or a solid polymer electrolyte with high conductivity is needed. The new concept electrolytes described in this invention are ideal for lithium secondary batteries. They do not evaporate up to 150° C., offer high ionic conductivity of over 10⁻⁴ S/cm around room temperature, and have a wide electrochemical stability window of over 4.5 V (vs. lithium).

The present inventors have developed a new type of metal ionic conductive electrolyte based on liquid cyclic poly(siloxane-g-ethylene oxide)s to overcome the above mentioned problems such as volatility, flammability and chemically reactivity in lithium batteries that are usually observed when using conventional carbonate based liquid electrolytes. The proposed cyclic poly(siloxane-g-ethylene oxide) materials also have a good electrochemical stability window and high room temperature ionic conductivity. The present inventors have also incorporated the liquid polymer into solid electrolytes with the same benefits.

The present inventors have considered the problems related to carbonate solvents in conventional lithium ion batteries and have concluded that to address these problems, new polymer materials that can readily dissolve metal salts to prepare electrolytes are needed for lithium storage cells and capacitors. The present inventors have developed new siloxane polymer structures with one or more poly(ethylene oxide) side chains. Siloxane is an inorganic material that is not readily decomposed by heat. When the material is thermally decomposed, only a few nonflammable by-products result from the decomposition process because the main chain is a Si—O linkage. This inhibits the combustion cycle.

Substantial research has been carried out regarding poly(siloxane-g-ethylene oxide). For example, U.S. Pat. No. 6,124,062 issued to Horie et al. (Sony Corporation, Japan) and U.S. Pat. No. 5,112,512 issued to Nakamura (Dow Corning Toray Silicone Co., Japan) describe using poly(siloxane-g-ethylene oxide) (see general formula I) as a polymeric electrolyte material.

General formula (I):

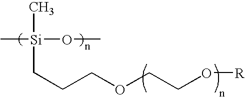

where, R is alkyl group.

Additionally, the present inventors have also carried out extensive research in this area. Previously, they invented another related liquid type siloxane polymer with one or more poly(ethylene oxide) as a side chain (see general formula II) that are directly bonded to Si atoms.

General formula (II):

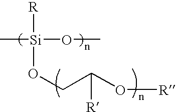

where, R and R″ are alkyl group and R′ is hydrogen or alkyl group.

This electrolyte is described in co-pending applications entitled “Nonaqueous Liquid Electrolyte” filed Jan. 30, 2003 and copending U.S. application Ser. No. 10/167,490 filed Jun. 12, 2002.

The present inventors subsequently discovered a more effective structure of the poly(siloxane-g-ethylene oxide) which is relatively easy to synthesize and achieves high ionic conductivity (approaching to 10⁻³ S/cm at around room temperature). The new liquid poly(siloxane-g-ethylene oxide)s have cyclic structure (see general formula III) that can easily coordinate with lithium salt and dissociate the salt. In addition, they also can be used as ionic conductors of solid polymer electrolytes by entrapping them inside crosslinked polymer networks, or mixing with solid polymers such as polyacrylonitrile (PAN), poly(methyl methacrylate) (PMMA), poly(vinylidene fluoride) (PVdF), poly(vinylidene fluoride-co-hexafluoropropylene), poly(vinyl acetate), polystyrene, poly(ethylene oxide) (PEO), etc.

General formula (III):

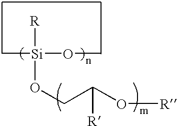

where, R and R″ are alkyl group and R′ is hydrogen or alkyl group; n=2 to 10; m represents=1 to 50.

A primary object of the present invention is to provide a liquid polymer electrolyte solution having increased room temperature ionic conductivity and enhanced safety characteristics.

Another object of the invention is to provide a liquid polymer electrolyte solution with a controlled viscosity for high-energy and long-life lithium secondary batteries, especially for biomedical devices, electric and hybrid vehicles, consumer electronics, submarines, and satellites.

A further object of the invention is to provide an electrochemical cell with enhanced shelf life and safety by the use of the present polymeric electrolyte.

### SUMMARY

To fulfill the above objects, the liquid polymer electrolyte solution in the present invention is prepared by using the composition which comprises liquid cyclic poly(siloxane-g-ethylene oxide) with proper viscosity and a lithium salt.

### BRIEF DESCRIPTION OF THE DRAWINGS

FIG. 1 is a summary of the synthesis of one species of the polysiloxane of present invention.

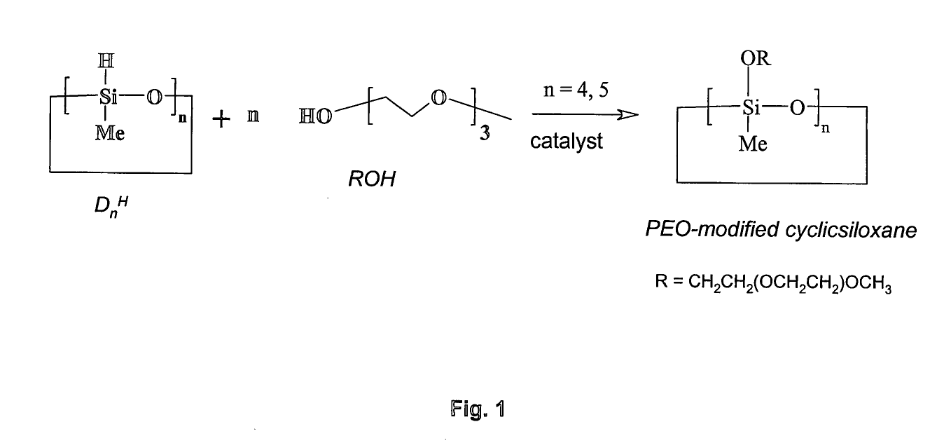

FIG. 2 is a plot of temperature vs. conductivity for poly(siloxane-g-3 ethylene oxide) electrolyte.

### DETAILED DESCRIPTION

The electrolyte solution of the present invention comprises cyclic siloxane polymers with poly(ethylene oxide) as a side chain (see general formula III). The cyclic type siloxane main body provides flame-retardant properties and chemical stability, and poly(ethylene oxide) side chains give ionic conducting phases. Poly(ethylene oxide) group is directly grafted to silicon atoms in the cyclic siloxane polymer. Cyclic poly(siloxane-g-ethylene oxide)s of the present invention are easily synthesized through simple dehydrogenation reaction using mild catalysts (e.g. aryl borate or potassium carbonate). These catalysts avoid problems arising from the use of metal catalysts such as platinum for the synthesis of poly(siloxane-g-ethylene oxide) with an alkylene spacer between the silicon atom and poly(ethylene oxide) (see general formula I above).

The cyclic poly(siloxane-g-ethylene oxide) easily dissolves lithium salt and has enough flexibility to transport lithium ion. The viscosity of poly(siloxane-g-ethylene oxide) can be optimized by controlling the size of siloxane ring or the length of poly(ethylene oxide) side chain. By so optimizing the viscosity, the polymeric electrolyte solution provides high ionic conductivity of close to 10⁻³ S/cm at around room temperature.

The lithium salt to be used in the present invention is not particularly limited, as long as it serves as an electrolyte for a lithium secondary battery. Examples of specific lithium salts include LiClO₄, LiBF₄, LiAsF₆, LiPF₆, LiCF₃SO₃, Li(CF₃SO₂)₂N, Li(CF₃SO₂)₃C, LiN(SO₂C₂F₅)₂), lithium alkyl fluorophosphates, lithium oxalatoborate, as well as other lithium bis(chelato)borates having five to seven membered rings, LiPF₃(C₂F₅)₃, LiPF₃(CF₃)₃, LiB(C₂O₄)₂, and mixtures thereof.

The molar ratio of the side-chain oxygen of poly(siloxane-g-ethylene oxide), m in General Formula III, to the lithium salt is preferably about 5 to 50. If the proportion of side-chain oxygen is larger than 50, the ionic conductivity of the resulting polymeric electrolyte is undesirably decreased because of the inadequate numbers of carrier ions in the solid polymer electrolyte. If the molar ratio is smaller than 5, the lithium salt is not sufficiently dissociated in the resulting polymeric electrolyte and the aggregation of lithium ions can reduce the ionic conductivity.

The polymeric electrolyte solution of the present invention can be applied in lithium secondary batteries in the same way as common carbonate-based electrolyte solutions. Lithium secondary batteries with the present invention's polymeric electrolyte solution as a conducting medium can be fabricated by injecting the polymeric electrolyte solution into a spiral wound cell or prismatic type cell (laminated, Z-fold, etc.). It can also be coated onto the surface of electrodes and assembled with a porous separator to fabricate a single or multi-stacked cell that is packaged in a plastic or plastic/foil laminated pouch. Additionally, the electrolyte of the present invention can be mixed with the active material, the binder and the electronic additive (a conductor typically made from graphite, carbon black, acetyl black, or other carbonaceous material) to form a slurry and then cast the slurry with an embedded current collector to obtain a composite electrode after drying.

### EXAMPLES

### Example 1

Eight-membered ring poly(siloxane-g-3 ethylene oxide) (see general formula IV) was synthesized (Sample W98) using a boron catalyst as follows:

To a 500-mL flame-dried flask was added D₄^{H} (Gelest Inc., 46.92 g, 0.78 mol Si—H), tri(ethyleneglycol) monomethyl ether (Aldrich, 128.22 g, 0.78 mol), toluene (210 mL, dried over sodium prior to use), and tris(pentafluorophenyl)boron B(C₆F₅)₃ (Aldrich, 0.16 g, 0.31 mmol) under nitrogen atmosphere. The clear solution was heated to 70-75° C. Bubbling was observed at this point. The reaction mixture was continuously stirred at this temperature for about 48 hours until the bubbling stopped. After the solvent was removed on a rotary evaporator, the colorless liquid was further purified by removing the all volatiles at about 150° C./0.1 torr to afford a colorless oil (158.8 g). IR showed no HO groups and no Si—H present.

The eight-membered ring poly(siloxane-g-3 ethylene oxide) so synthesized and LiN(SO₂CF₃) were mixed with the ratio of [EO]/[Li]=32:1. The ionic conductivity of the polymeric electrolytes at 25° C. was measured from the AC impedance curves of 2030 button cells assembled by injecting the polymeric electrolyte between two stainless steel discs with a Teflon O-ring (1/32 inch thick) to prevent short circuits. The measurement frequency range was from 1 MHz to 100 Hz.

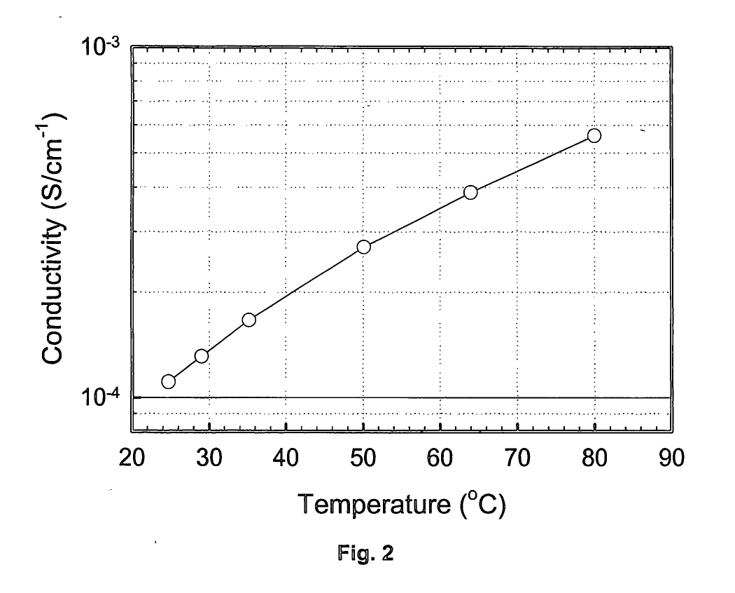

Referring to FIG. 2, it may be seen that poly(siloxane-g-3 ethylene oxide) electrolyte shows high ionic conductivity of 1.13×10⁻⁴ S/cm at 25° C. In addition, Table 1 reports the results of conductivity testing of both 8 member and 10 member ring molecules. It may be seen that the two 8 membered ring samples (n=4) made with different catalysts (see Example 3 below) and the 10 membered ring samples (see Example 2 below) showed favorable conductivity.

TABLE 1
Room Temperature Conductivity: Cyclic Oligomers

| | | | | σ × | Vis- | | |
|---|---|---|---|---|---|---|---|
| | | | | 10⁴ | cosity | | |
| | | T | | (Ω⁻¹ · | η | | Ref. |
| Structures | n | (° C.) | O/Li | cm⁻¹) | (cPs) | Catalyst | # |
| 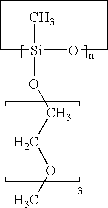 | 5 5 5 5 5 4 4 | 25 25 25 25 25 25 25 | 23.9 15.3 29 32 32 24 32 | 1.43 1.15 1.15 1.31 1.04 1.67 1.13 | 50 50 50 50.0 83.6 | | |
| # 61.4 44.5 | B(C₆F₅)₃B(C₆F₅)₃B(C₆F₅)₃B(C₆F₅)₃Et₃N Et₃N B(C₆F₅)₃ | W81 W81 W81 W96 W91 W92 W98 | | | | | |

### Example 2

A 10-membered ring poly(siloxane-g-3 ethylene oxide) was synthesized (Sample W96) using a boron catalyst as follows:

The same procedures as for the above Example 1 were followed: To a 500-mL flame-dried flask was added D₅^{H} (Gelest Inc., 22.26 g, 0.38 mol Si—H), tri(ethyleneglycol) monomethyl ether (Aldrich 62.21 g, 0.38 mol); toluene (100 mL, dried over sodium prior to use); and tri(pentafluoropenyl)boron B(C₆F₅)₃ (Aldrich, 0.08 g, 0.16 mmol) to afford colorless oil product (73.7 g). Conductivity for this sample, as can be seen in Table 1, was 1.31×10⁴Ω⁻¹ cm⁻¹. Example 3: Eight-membered ring poly(siloxane-g-3 ethylene oxide) (see general formula IV) was synthesized (Sample W92) using triethylamine (Et₃N) as a catalyst as follows:

Triethylamine (Aldrich, 73 ml, 52.50 g, 0.52 mol) was slowly added through a syringe to the cloudy mixture of D₄^{H} (Gelest Inc., 31.25 g, 0.52 mol Si—H) and tri(ethyleneglycol) monomethyl ether (Aldrich, 85.30 g, 0.52 mol) at 0° C. under nitrogen atmosphere. Vigorous bubbling was observed. After completion of the addition of triethylamine (in about two hours), the clear solution was continuously stirred in an ice-water bath until the bubbling subsided. The reaction mixture was stirred at about 60° C. (for about 68 hours) until no Si—H groups were observed by IR. After the solvent was removed, the colorless liquid was further purified by removing the all volatiles at about 140° C./0.5 torr to afford a light brown oil (71.6 g). Referring to Table 1, conductivity measured for this sample was 1.67×10⁴Ω⁻¹ cm⁻¹.

### Example 4

A freestanding solid polymer electrolyte was prepared using the interpenetrating polymerization technique. It was made up of an 8-membered ring poly(siloxane-g-3 ethylene oxide) electrolyte (see general formula IV), poly(ethylene oxide) dimethacrylate as a network forming agent, benzoyl peroxide as a radical initiator and LiN(SO₂CF₃)₂ (LiTFSI) as a lithium salt. The reaction was cured at 70° C. for 2 hrs. The ionic conductivity of the polymeric electrolytes at 37° C. was measured from the AC impedance curves of 2030 button cells assembled by interposing the polymeric electrolyte between two stainless steel discs. The measurement frequency range was from 1 MHz to 10 Hz.

General Formula (IV):

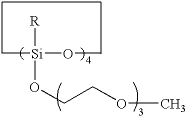

### PREFERRED EMBODIMENT

The preferred embodiment of the invention is poly(siloxane-g-ethylene oxide) with a molar ratio of the side-chain oxygen of poly(siloxane-g-ethylene oxide), m in General Formula III, to the lithium salt equal to about 5 to 50. Any commonly used lithium salt is acceptable including, without limitation, LiClO₄, LiBF₄, LiAsF₆, LiPF₆, LiCF₃SO₃, Li(CF₃SO₂)₂N, Li(CF₃SO₂)₃C, LiN(SO₂C₂F₅)₂), lithium alkyl fluorophosphates, lithium oxaloborate, and mixtures thereof. The average molecular weight of the liquid poly(siloxane-g-ethylene oxide) is optimally less than or equal to 20,000 g/mole. The optimal viscosity of the electrolyte of the present invention is about 10,000 cps or less. Tris(pentafluorophenyl)boron B(C₆F₅)₃ is the preferred catalyst. Where a solid electrolyte is desired, the preferred network forming polymer comprises poly(alkylene oxide) dialkyl alkyl acrylates represented by General Formula (V):

General Formula (V):

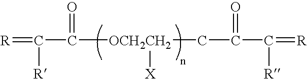

wherein R represents a group selected from an alkyl group having 1 to 10 carbon atoms; and each of R′ and R″ represents hydrogen or a group selected from an alkyl group having 1 to 10 carbon atoms and/or an alkenyl group having 2 to 12 carbon atoms; and X being hydrogen or a methyl group; and n represents numeral of 1 to 15.

The specific implementations disclosed above are by way of example and for enabling persons skilled in the art to implement the invention only. We have made every effort to describe all the embodiments we have foreseen. There may be embodiments that are unforeseeable or which are insubstantially different. We have further made every effort to describe the invention, including the best mode of practicing it. Any omission of any variation of the invention disclosed is not intended to dedicate such variation to the public, and all unforeseen or insubstantial variations are intended to be covered by the claims appended hereto. Accordingly, the invention is not to be limited except by the appended claims and legal equivalents.

1. A polymer electrolyte for electrochemical storage devices comprising cyclic poly(siloxane-g-ethylene oxide) represented by general formula: 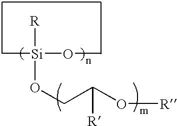
wherein, R and R″ are alkyl group;
R′ is hydrogen or alkyl group;
n=2 to 20, and
m=1 to 50.

2. The polymer electrolyte of claim 1 wherein said electrolyte is a liquid comprising cyclic poly(siloxane-g-ethylene oxide) and at least one alkali metal salt.

3. The polymer electrolyte of claim 1 wherein said electrolyte is a solid comprising cyclic poly(siloxane-g-ethylene oxide), at least one alkali metal salt and one or more solidifying polymers.

4. The polymer electrolyte of claim 3, wherein said one or more solidifying polymers are selected from the group consisting of network forming polymer and solid polymer.

5. The polymer electrolyte of claim 3, wherein said one or more solidifying polymers comprises poly(ethylene oxide) dimethacrylate.

6. The polymer electrolyte of claim 1 wherein said electrolyte is entrapped inside crosslinked polymer networks.

7. The polymer electrolyte of claim 1 wherein said electrolyte is mixed with solid polymers.

8. The polymer electrolyte recited in claim 7 wherein said solid polymers comprise at least one solid polymer selected from the group consisting of: polyacrylonitrile (PAN), poly(methyl methacrylate) (PMMA), poly(vinylidene fluoride) (PVdF), poly(vinylidene fluoride-co-hexafluoropropylene), poly(vinyl acetate), polystyrene, and poly(ethylene oxide) (PEO).

9. The polymer electrolyte of claim 1, wherein the average molecular weight of the poly(siloxane-g-ethylene oxide) is less than or equal to 20,000 g/mol.

10. The polymer electrolyte of claim 1, wherein the dynamic viscosity of the poly(siloxane-g-ethylene oxide) is less than or equal to 10,000 cps.

11. The polymer electrolyte of claim 1, further comprising a lithium salt.

12. The polymer electrolyte of claim 11, wherein the molar ratio of [EO]/[Li] is 5 to 50.

13. The polymer electrolyte of claim 10, wherein the lithium salt comprises at least one lithium salt selected from the group consisting of: LiCIO₄, LiBF₄, LiAsF₆, LiPF₆, LiCF₃SO₃, Li(CF₃SO₂)₂N, Li(CF₃SO₂)₃C, LiN(SO₂C₂F₅)₂), lithium alkyl fluorophosphates, lithium oxalatoborate, lithium bis(chelato)borates, LiPF₃(C₂F₅)₃, LiPF₃(CF₃)₃, LiB(C₂O₄)₂.

14. The polymer electrolyte of claim 13 wherein said lithium bis(chelato)borate has 5 to 10 membered rings.

15. The polymer electrolyte of claim 13 wherein said lithium bis(chelato)borates has 5 to 7 membered rings.

16. The polymer electrolyte of claim 13, further comprising a network forming polymer.

17. The polymer electrolyte of claim 16 wherein said network forming polymer comprises poly(alkylene oxide) dialkyl alkyl acrylates represented by general formula: 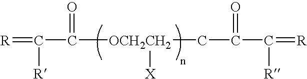
wherein R represents a group selected from an alkylidene group having 1 to 10 carbon atoms; and each of R′ and R″ represents hydrogen or a group selected from an alkyl group having 1 to 10 carbon atoms and/or an alkenyl group having 2 to 12 carbon atoms; and X being hydrogen or a methyl group; and n represents numeral of 1 to 15.

18. The polymer electrolyte of claim 13, further comprising a solid polymer.

19. The polymer electrolyte of claim 18 wherein said solid polymer comprises at least one polymer selected from the group consisting of: polyacrylonitrile (PAN), poly(methyl methacrylate) (PMMA), poly(vinylidene fluoride) (PVdF), poly(vinylidene fluoride-co-hexafluoropropylene), poly(vinyl acetate), polystyrene, and poly(ethylene oxide) (PEO).

20. An electrochemical device comprising the polymer electrolyte recited in claim 1.

21. The electrochemical device recited in claim 20 wherein said electrochemical device comprises a lithium secondary battery further comprising at least one lithium metal oxide cathode, at least one porous separator and at least one anode.

22. The electrochemical device recited in claim 21 wherein said at least one anode comprises at least one material selected from the group consisting of carbon and lithium metal.

23. The electrochemical device recited in claim 20 wherein said electrochemical device comprises a capacitor.

24. A method for synthesizing cyclic poly(siloxane-g-ethylene oxide) comprising the acts of:
providing tri(ethyleneglycol) monomethyl ether;
providing a solvent;
providing a catalyst;
drying all components;
mixing and heating all components;
removing said solvent; and
removing all volatiles.

25. The method recited in claim 24 wherein said catalyst contains boron.

26. The method recited in claim 24 wherein said catalyst comprises B(C₆F₅)₃.

27. The method recited in claim 24 wherein said catalyst comprises triethylamine.

28. The method recited in claim 24 wherein said solvent comprises toluene.

29. The method recited in claim 24 wherein said heating is to about 70-75° C.

30. The method recited in claim 24 wherein said act of removing all volatiles comprises heating to about 150° C. in a reduced atmospheric pressure of about 0.1 torr.
